(19) United States
(12) Patent Application Publication
(10) Pub. No.: US 2023/0056749 A1
(43) Pub. Date: Feb. 23, 2023

(54) INTRUSION DETECTION AND PREVENTION SOLUTION SYSTEM IN IOT NETWORK USING EXPLAINABLE AI

(71) Applicant: Korea University Research and Business Foundation, Seoul (KR)

(72) Inventors: Huy Kang KIM, Seoul (KR); Hyunjae KANG, Seoul (KR); Jeong Do YOO, Seoul (KR); Young Hun LEE, Seoul (KR); Young-Ah CHOI, Gwangju-si (KR); Yong Sik KIM, Seoul (KR)

(73) Assignee: Korea University Research and Business Foundation, Seoul (KR)

(21) Appl. No.: 17/890,608

(22) Filed: Aug. 18, 2022

(30) Foreign Application Priority Data
Aug. 18, 2021 (KR) 10-2021-0108776

(51) Int. Cl. H04L 9/40; G06N 3/04; G06N 3/08

(52) U.S. Cl. CPC H04L 63/1441; H04L 63/1416; G06N 3/049; G06N 3/088

(57) ABSTRACT

Disclosed is a method for preventing an attack on an IoT network. The method may further include: generating attack situation information of an attack on a network by inputting one or more packet data for the IoT network into an attack discrimination unit; generating, by an attack analysis unit, main feature information for the attack based on the attack situation information; and generating, by an attack prevention unit, attack prevention information based on the main feature information, in which the attack discrimination unit may be an artificial neural network model of a modified autoencoder structure including a softmax layer.

### CROSS-REFERENCE TO RELATED APPLICATIONS

This application claims priority to and the benefit of Korean Patent Application No. 10-2021-0108776 filed in the Korean Intellectual Property Office on Aug. 18, 2021, the entire contents of which are incorporated herein by reference.

### TECHNICAL FIELD

The present disclosure relates to a method and a system for detecting an IoT network attack and preventing an attack, and particularly, to a method and a system for detecting an IoT network attack and preventing an attack by using an artificial intelligence model.

### BACKGROUND ART

IoT as a short word of Internet of Things means a device that connects things and an environment, things and things, etc., through the Internet, and provides people with convenience through mutual communication. A current IoT network constitutes a network environment in which numerous IoTs are connected to an existing network to which the Internet is connected or a new environment to include various device components. Since a security standard for such a configured IoT is not yet specifically enacted and uses various connection protocols for each IoT, there can be various security risks and threats. In particular, since the IoT network is closely related to life and provides automated services, when an external attack on the IoT network is detected, it is necessary to immediately announce the external attack to a user.

An attack detection technology on the existing IoT network is performed through computing power and a mathematical algorithm without direct intervention by a user by using an artificial intelligence technology. However, an attack detection method on a network in an existing IoT technical field provides the user only with a detection result and does not provide the user with a ground for the detection and detailed analysis contents, and as a result, there is a problem in that reliability for a detection method cannot be identified. Further, in the existing IoT technical field, a system and a method which automatically respond to the attack after detecting the network attack are not provided.

Therefore, a method and a system are required, which analyze the detected attack after detecting the attack in the IoT network and provide the user with an analysis result and automatically respond to the detected attack.

### SUMMARY OF THE INVENTION

The present disclosure has been made in an effort to provide a method and a computing device for detecting an IoT network attack and preventing an attack.

However, technical objects of the present disclosure are not restricted to the technical object mentioned as above. Other unmentioned technical objects will be apparently appreciated by those skilled in the art by referencing to the following description.

An exemplary embodiment of the present disclosure provides a method for preventing an attack on an IoT network. The method may further include: generating attack situation information of an attack on a network by inputting one or more packet data for the IoT network into an attack discrimination unit; generating, by an attack analysis unit, main feature information for the attack based on the attack situation information; and generating, by an attack prevention unit, attack prevention information based on the main feature information, in which the attack discrimination unit may be an artificial neural network model of a modified autoencoder structure including a softmax layer.

Alternatively, the method may further include: generating feature packet data for a predetermined analysis time by inputting learning packet data into a preprocessing unit; generating, by a learning data generation unit, primary learning data and secondary learning data based on the feature packet data; and training the attack discrimination unit by using the primary learning data and the secondary learning data, in which the feature packet data may include one or more features extracted from the learning packet data for the analysis time.

Alternatively, the generating, by the learning data generation unit, of the primary learning data and the secondary learning data based on the feature packet data may further include generating the primary learning data related to one of a normal state or an attack based on the feature packet data; and generating the secondary learning data by labeling the feature packet data with at least one attack type.

Alternatively, the training of the attack discrimination unit by using the primary learning data and the secondary learning data may include performing primary learning by inputting the primary learning data into a primary discrimination model constituted by an autoencoder, constituting the attack discrimination unit by adding the softmax layer to the primary discrimination model of which primary learning is completed; and performing secondary learning by inputting the secondary learning data into the attack discrimination unit in order to generate the attack situation information including whether the attack occurs and the type of attack.

Alternatively, the generating of the attack situation information of the attack on the network by inputting one or more packet data for the IoT network into the attack discrimination unit may include calculating, by the attack discrimination unit, one or more loss values for the packet data, and calculating a mean loss value of the packet data, discriminating at least one of whether the attack occurs or the attack type based on the mean loss value, and generating the attack situation information including at least one whether the attack occur or the attack type discriminated.

Alternatively, the discriminating of at least one of whether the attack occurs or the attack type based on the mean loss value may include at least one of discriminating whether the attack occurs by comparing the mean loss value with a predetermined loss threshold value, or discriminating, by the attack discrimination unit, the attack type by comparing the mean loss value with a reference mean loss value of each of the learned attack types.

Alternatively, the generating, by the attack analysis unit, of the main feature information having a high relation to the attack based on the attack situation information includes when the attack analysis unit identifies that the attack occurs based on whether the attack is performed in the attack situation information, identifying, by the attack analysis unit, the attack type of the attack situation information, calculating, by the attack analysis unit, one or more Shapley values for features of the identified attack type, and determining, by the attack analysis unit, at least one of the features as a main feature based on the Shapley value and generating the main feature information including one or more main features.

Alternatively, the generating, by the attack analysis unit, of the main feature information having a high relation to the attack based on the attack situation information may further include generating, by the attack analysis unit, visualization analysis information representing the Shapley value of each of the features.

Alternatively, the attack prevention information may include conditional information for a main feature included in the main feature information, and behavior information for performing a network related control operation based on the conditional information.

Another exemplary embodiment of the present disclosure provides a computing device for preventing an attack on an IoT network. The computing device may include: a processor; a memory; and a network unit 110, in which the processor may be configured to generate attack situation information of an attack on a network by inputting one or more packet data for the IoT network into an attack discrimination unit, generate, by an attack analysis unit, main feature information for the attack based on the attack situation information, and generate, by an attack prevention unit, attack prevention information based on the main feature information, and the attack discrimination unit may be an artificial neural network model of a modified autoencoder structure including a softmax layer.

According to an exemplary embodiment of the present disclosure, a method for detecting an attack on an IoT network and preventing the detected attack can be provided.

Effects which can be obtained in the present disclosure are not limited to the aforementioned effects and other unmentioned effects will be clearly understood by those skilled in the art from the following description.

### BRIEF DESCRIPTION OF THE DRAWINGS

Various aspects are now described with reference to the drawings and like reference numerals are generally used to designate like elements. In the following exemplary embodiments, for the purpose of description, multiple specific detailed matters are presented to provide general understanding of one or more aspects. However, it will be apparent that the aspect(s) can be executed without the detailed matters.

FIG. 1 is a block diagram of a computing device for preventing an attack on an IoT network according to an exemplary embodiment of the present disclosure.

FIG. 2 is a block diagram exemplarily illustrating an attack prevention solution system for preventing an attack in an IoT network according to an exemplary embodiment of the present disclosure.

FIG. 3 is a schematic view illustrating an exemplary network function according to an exemplary embodiment of the present disclosure.

FIG. 4A is an exemplary diagram exemplarily illustrating a primary discrimination model constituted by an autoencoder according to an exemplary embodiment of the present disclosure.

FIG. 4B is an exemplary diagram exemplarily illustrating an attack discrimination unit including an autoencoder and a softmax layer according to an exemplary embodiment of the present disclosure.

FIG. 5 is an exemplary diagram exemplarily illustrating visualization analysis information according to an exemplary embodiment of the present disclosure.

FIG. 6 is an exemplary diagram exemplarily illustrating attack prevention information according to an exemplary embodiment of the present disclosure.

FIG. 7 is a flowchart for a method for preventing an attack in IoT network according to an exemplary embodiment of the present disclosure.

FIG. 8 is a simple and general schematic view of an exemplary computing environment in which exemplary embodiments of the present disclosure may be implemented.

### DETAILED DESCRIPTION

Various exemplary embodiments will now be described with reference to drawings. In the present specification, various descriptions are presented to provide appreciation of the present disclosure. However, it is apparent that the exemplary embodiments can be executed without the specific description.

“Component”, “module”, “system”, and the like which are terms used in the specification refer to a computer-related entity, hardware, firmware, software, and a combination of the software and the hardware, or execution of the software. For example, the component may be a processing procedure executed on a processor, the processor, an object, an execution thread, a program, and/or a computer, but is not limited thereto. For example, both an application executed in a computing device and the computing device may be the components. One or more components may reside within the processor and/or a thread of execution. One component may be localized in one computer. One component may be distributed between two or more computers. Further, the components may be executed by various computer-readable media having various data structures, which are stored therein. The components may perform communication through local and/or remote processing according to a signal (for example, data transmitted from another system through a network such as the Internet through data and/or a signal from one component that interacts with other components in a local system and a distribution system) having one or more data packets, for example.

The term “or” is intended to mean not exclusive “or” but inclusive “or”. That is, when not separately specified or not clear in terms of a context, a sentence “X uses A or B” is intended to mean one of the natural inclusive substitutions. That is, the sentence “X uses A or B” may be applied to any of the case where X uses A, the case where X uses B, or the case where X uses both A and B. Further, it should be understood that the term “and/or” used in this specification designates and includes all available combinations of one or more items among enumerated related items.

It should be appreciated that the term “comprise” and/or “comprising” means presence of corresponding features and/or components. However, it should be appreciated that the term “comprises” and/or “comprising” means that presence or addition of one or more other features, components, and/or a group thereof is not excluded. Further, when not separately specified or it is not clear in terms of the context that a singular form is indicated, it should be construed that the singular form generally means “one or more” in this specification and the claims.

The term “at least one of A or B” should be interpreted to mean “a case including only A”, “a case including only B”, and “a case in which A and B are combined”.

Those skilled in the art need to recognize that various illustrative logical blocks, configurations, modules, circuits, means, logic, and algorithm steps described in connection with the exemplary embodiments disclosed herein may be additionally implemented as electronic hardware, computer software, or combinations of both sides. To clearly illustrate the interchangeability of hardware and software, various illustrative components, blocks, configurations, means, logic, modules, circuits, and steps have been described above generally in terms of their functionalities. Whether the functionalities are implemented as the hardware or software depends on a specific application and design restrictions given to an entire system. Skilled artisans may implement the described functionalities in various ways for each particular application. However, such implementation decisions should not be interpreted as causing a departure from the scope of the present disclosure.

The description of the presented exemplary embodiments is provided so that those skilled in the art of the present disclosure use or implement the present disclosure. Various modifications to the exemplary embodiments will be apparent to those skilled in the art. Generic principles defined herein may be applied to other embodiments without departing from the scope of the present disclosure. Therefore, the present disclosure is not limited to the exemplary embodiments presented herein. The present disclosure should be analyzed within the widest range which is coherent with the principles and new features presented herein.

In the present disclosure, a network function and an artificial neural network and a neural network may be interchangeably used.

An IoT network of the present disclosure may be a network for a plurality of device, and here, the device may include remotely controllable devices such as home appliances, terminals, or wearable devices. For example, the devices used in the IoT network may be a smart speaker, a refrigerator, a TV, a smartphone, or a smart watch, but the devices of the present disclosure are not limited to the above-described examples.

Packet data of the present disclosure may be a data block or a data bundle transferred through a network by the unit of a packet, and the packet data may also be a general network packet. Further, the packet data of the present disclosure may include data generated in real time in relation to a network environment. The packet data of the present disclosure may also include at least one of data related to a normal network or data related to a network receiving an attack.

In the present disclosure, a feature may be some information of the data related to the network, which may be extracted from the data included in the packet data. Specifically, the feature may be extracted by inputting the packet data or learning packet data into a preprocessing unit, and the feature of the present disclosure may include a basic feature and a statistical feature.

The basic feature of the present disclosure may also be basic information related to the network of the packet data. For example, the basic feature of the present disclosure may be a source IP, a destination IP, a source port, a destination port, a protocol type, type of service (TOS), a TCP control flag, or a length in a header of the packet data, but the basic feature of the present disclosure is not limited to the above-described examples.

The statistical feature of the present disclosure may be information that may calculate statistics among network related information of packet data collected during a predetermined analysis time. Specifically, one or more packet data collected for the predetermined analysis time may be identified based on a timestamp of each packet data in the preprocessing unit. In addition, one or more statistical features that may calculate the statistics for the data included in each of one or more packet data identified in the preprocessing unit may be identified. In addition, the statistics for the statistical feature identified by the preprocessing unit may be calculated and the statistical feature related to each of the calculated statistics may be matched. Here, the method for calculating the statistics may be a calculation method such as averaging or totaling, but the statistics of the present disclosure are limited to the above-described calculation methods, and not calculated. The statistical feature may be predetermined by a user or information capable of calculating the statistics among the information of the data included in the packet data may also be identified and determined as the statistical feature by the preprocessing unit.

The statistical feature of the present disclosure may be, for example, the number of packet data sent in the same source IP for a predetermined analysis time, the number of packet data received in the same destination IP for the predetermined analysis time, the number of packet data sent in the same source IP and source port for the predetermined analysis time, or the number of packet data received in the same destination IP and destination port for the predetermined analysis time. The statistical features are just examples, and the statistical feature of the present disclosure should be limited and not interpreted due to the examples.

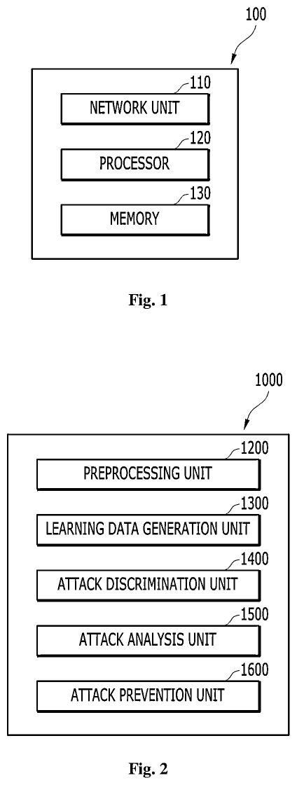

As described above, preprocessing performed by the preprocessing unit of the present disclosure may be data preprocessing that extracts the feature from the data. Further, a preprocessing method performed by the preprocessing unit of the present disclosure may include at least one step of a step of extracting the data input into the preprocessing unit for the predetermined time or a step of extracting at least one of the basic feature or the statistical feature which is the above-described feature from the input data. The preprocessing of the preprocessing unit performed by the present disclosure will be hereinafter described in detail with reference to FIGS. 1 to 3.

The learning packet data of the present disclosure may be packet data for generating learning data used for training an attack discrimination unit. Specifically, primary learning data and secondary learning data for training the attack discrimination unit of the present disclosure may be generated based on the learning packet data. More specifically, the learning packet data may be preprocessed by the preprocessing unit and generated as feature packet data, and the primary learning data and the second learning data may be generated based on the feature packet data.

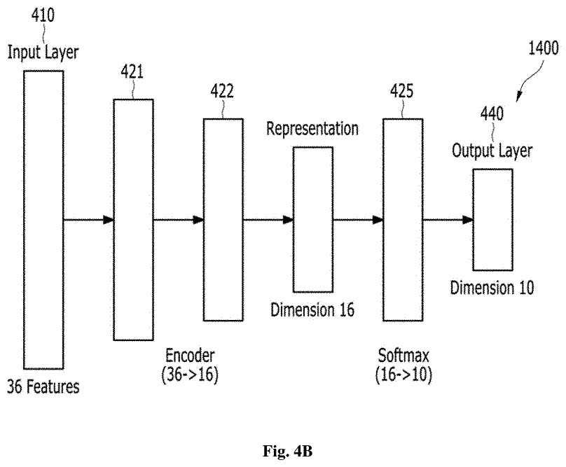

The primary learning data of the present disclosure may be learning data for an autoencoder part of the attack discrimination unit to primarily learn the packet data related to one of a network attack or a normal state. Further, the secondary learning data of the present disclosure may be learning data for the attack discrimination unit including the autoencoder and a softmax layer to secondarily learn whether a network attack is performed and an attack type. Primary learning and secondary learning will be hereinafter described in detail with reference to FIGS. 4A and 4B.

The feature packet data of the present disclosure may be data including one or more features extracted by preprocessing the learning packet data by the preprocessing unit. Specifically, the features may be extracted from the learning packet data for the predetermined analysis time through the preprocessing unit, and the feature packet data including the extracted features may be generated. The learning packet data may be data related to one of the network attack or the normal state, and as a result, the feature packet data may also be data related to one of the attack or the normal state.

In the present disclosure, the primary learning data related to one of the normal state or the attack may be generated based on the feature packet data. Further, in the present disclosure, the secondary learning data may be generated by labeling the specific packet data related to the network attack among one or more specific packet data with the attack type. The attack discrimination unit may be trained by using the generated primary learning data and secondary learning data, and contents regarding the training of the attack discrimination unit will be hereinafter described in detail with reference to FIGS. 4A and 4B.

The learning packet data of the present disclosure may be one of packet data collected in real time or prestored packet data. That is, in the present disclosure, the packet data collected in real time may be used as the learning packet data for the network or learning packet data which the user inputs in advance may also be used. One or more learning packet data may also be used for training the attack discrimination unit of the present disclosure.

The attack of the present disclosure may be the attack for the network, and specifically, when there is the packet data related to the attack for the predetermined analysis time, it may be recognized that there is the attack. The attack in the network may mean interfering, weakening, removing, disturbing, rejecting, damaging, or destroying information which resides in a computer and a computer network or a computer network itself. Here, the information which resides in the network may be important information such as personal information, and the personal information may also be leaked or changed due to the network attack.

For example, the attack in the network may be Danial of Service (DoS) attack, Distributed Denial of Service (DDoS) attack, Sniffing, Spoofing, Switch Jamming, Land Attack, or PORT Scanning. The attacks in the network are just examples, and the attack in the network of the present disclosure is not limited to the above-described examples.

Attack situation information of the present disclosure may be information on the network attack generated in the attack discrimination unit based on the collected packet data. The attack situation information may include at least one of information on whether the attack being performed or the attack type information, and the attack discrimination unit may also generate one or more different attack situation information.

For example, the attack discrimination unit may generate first attack situation information and second attack situation information. Here, the first attack situation information may include normal state information in which there is no attack, and the second attack situation information may include attack state information in which there is the attack and attack type information on the attack being a DDoS attack type. The first attack situation information, the second attack situation information, and the attack type are just an example, and the number of attack situation information and the attack type generated by the attack discrimination unit of the present disclosure should be limited and not interpreted due to the above-described examples.

The attack type of the present disclosure may mean a type of attack in the network. As in the examples of the attack in the network, the attack type of the present disclosure may be Danial of Service (DoS) attack, Distributed Denial of Service (DDoS) attack, Sniffing, Spoofing, Switch Jamming, Land Attack, or PORT Scanning. The attack types are just examples, and the attack types of the present disclosure are not limited to the above-described examples. The attack type of the present disclosure may be determined by the attack discrimination unit based on the received packet data.

Main feature information of the present disclosure may be information on main features which exert a large influence on determining the attack type by the attack discrimination unit. The main features which exert the large influence on determining the attack type may be features of the packet data which are a decisive basis for determining the attack type by the attack discrimination unit. The main features may be determined based on a Shapley value for determining a feature importance by an attack analysis unit. That is, a largest feature of the Shapley value may become a largest cause for determining the attack type, and determined as the main feature. As a result, main feature information may include the Shapley value and main features matching the Shapley value.

The main feature of the present disclosure may be a feature that the Shapley value has a Shapley value larger than a predetermined reference Shapley value. Alternatively, among features which are arranged in the order of a largest Shapley value, features selected as large as a predetermined reference number may also be determined as the main feature.

For example, for attack type A, the main feature information may include first to third features, and a Shapley value matching the first feature may be 0.01, a Shapley value matching the second feature may be 0.12, and a Shapley value matching the third feature may be 0.20. Here, the third feature among the first to third features may be a feature which exerts the largest influence, and it may be regarded that the third feature has the largest importance. When the reference Shapley value is 0.10, the second and third features may be the main features.

As another example, the Shapley value of the first feature may be 0.01, the Shapley value of the second feature may be 0.04, and the Shapley value of the third feature may be 0.5. When a predetermined reference number is 2, the attack analysis unit may arrange the third feature, the second feature, and the first feature in order based on the Shapley value, and also determine the second and third features as the main features. As a result, the generated main feature information may include the second feature and the third feature.

The features and Shapley values are just the examples, and the features and Shapley values of the present disclosure should be limited and not interpreted due to the examples.

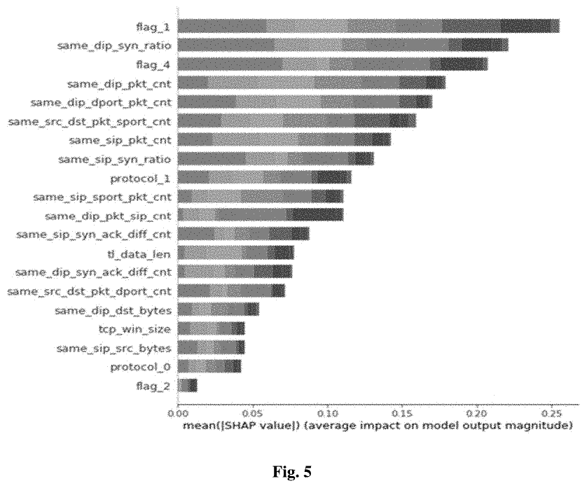

Visualization analysis information of the present disclosure may mean visualization information representing the Shapley values and features. Further, the visualization analysis information of the present disclosure may be information visually expressing the main feature information. The visualization analysis information may be visualization information such as a bar graph for the Shapley value for the features, as illustrated in FIG. 5, but the visualization analysis information of the present disclosure is not limited to the bar graph and a bar illustrated in FIG. 5. The visualization analysis information of the present disclosure may be generated by the attack analysis unit.

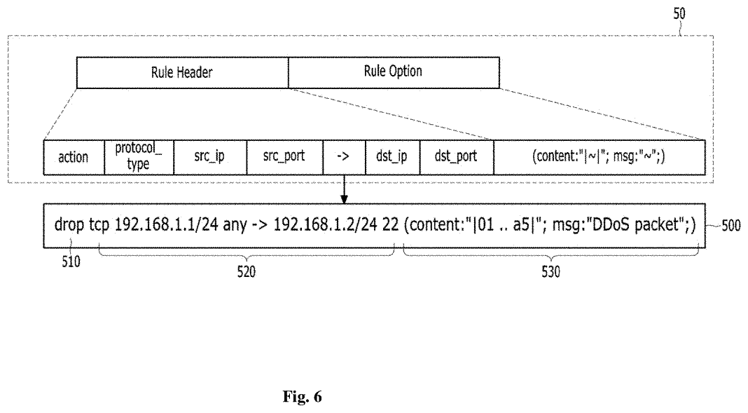

Attack prevention information of the present disclosure may be information for preventing the attack based on the attack type identified by the attack discrimination unit. Specifically, the attack prevent information of the present disclosure may be information on how to process the network or the packet data in order to prevent the attack of the identified attack type, and information corresponding to an attack prevention rule. Here, the attack prevention rule may be, for example, a Snort rule, but the attack prevention rule of the present disclosure is not limited to the snort rule. The attack prevent information of the present disclosure may include conditional information for the main feature included in the main feature information and behavior information for performing a network related control operation based on the conditional information. The attack prevention information of the present disclosure will be hereinafter described in detail with reference to FIG. 6.

FIG. 1 is a block diagram of a computing device for preventing an attack on an IoT network according to an exemplary embodiment of the present disclosure.

A configuration of the computing device 100 illustrated in FIG. 1 is only an example shown through simplification. In an exemplary embodiment of the present disclosure, the computing device 100 may include other additional components for performing a computing environment of the computing device 100 in addition to the components illustrated in FIG. 1 and only some of the components disclosed in FIG. 1 may also constitute the computing device 100.

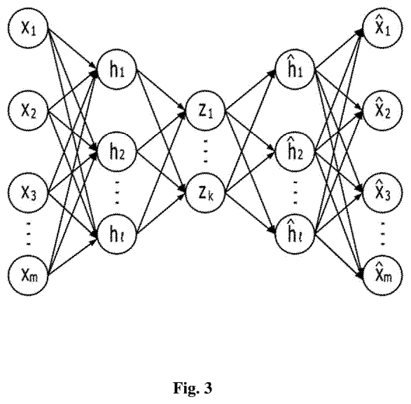

Specifically, the computing device 100 of the present disclosure may include a processor 120, a memory 130, and a network unit 110. Further, the computing device 100 of the present disclosure may further include an attack prevention system to perform at least some steps of a method for preventing an attack on an IoT network according to the present disclosure described below in detail with reference to drawings. Specifically, the attack prevention solution system for preventing the attack on the IoT network will be described as below with reference to FIG. 2.

FIG. 2 is a block diagram exemplarily illustrating an attack prevention solution system for preventing an attack on an IoT network according to an exemplary embodiment of the present disclosure.

The attack prevention solution system 1000 of the present disclosure may include at least one of a preprocessing unit 1200, a learning data generation unit 1300, an attack discrimination unit 1400, an attack analysis unit 1500, or an attack prevention unit 1600.

The preprocessing unit 1200, the learning data generation unit 1300, the attack discrimination unit 1400, the attack analysis unit 1500, and the attack prevention unit 1600 of the present disclosure may be included in the computing device 100, and operated and controlled so as to perform at least some steps of the method for preventing the attack on the IoT network of the present disclosure by the processor 120. As a result, the preprocessing unit 1200, the learning data generation unit 1300, the attack discrimination unit 1400, the attack analysis unit 1500, and the attack prevention unit 1600 of the present disclosure may be constituted by components, models, or modules which may be included in the computing device. Further, at least one of the preprocessing unit 1200, the learning data generation unit 1300, the attack discrimination unit 1400, the attack analysis unit 1500, and the attack prevention unit 1600 of the present disclosure may also be constituted by a separate processor 120.

The processor 120 may be constituted by one or more cores and may include processors 120 for data analysis and deep learning, which include a central processing unit (CPU), a general purpose graphics processing unit (GPGPU), a tensor processing unit (TPU), and the like of the computing device. The processor 120 may read a computer program stored in the memory 130 to perform data processing for machine learning according to an exemplary embodiment of the present disclosure. According to an exemplary embodiment of the present disclosure, the processor 120 may perform a calculation for learning the neural network. The processor 120 may perform calculations for learning the neural network, which include processing of input data for learning in deep learning (DL), extracting a feature in the input data, calculating an error, updating a weight of the neural network using backpropagation, and the like. At least one of the CPU, GPGPU, and TPU of the processor 120 may process learning of a network function. For example, both the CPU and the GPGPU may process the learning of the network function and data classification using the network function. Further, in an exemplary embodiment of the present disclosure, processors 120 of a plurality of computing devices may be used together to process the learning of the network function and the data classification using the network function. Further, the computer program executed in the computing device according to an exemplary embodiment of the present disclosure may be a CPU, GPGPU, or TPU executable program.

Specifically, the processor 120 may perform a calculation for training the attack discrimination unit 1400 constituted by the neural network, and as described above, at least one of the CPU, the GPGPU, and the TPU of the processor 120 may process the training for the network function of the attack discrimination unit 1400.

According to an exemplary embodiment of the present disclosure, the memory 130 may store any type of information generated or determined by the processor 120 and any type of information received by the network unit 110.

According to an exemplary embodiment of the present disclosure, the memory 130 may include at least one type of storage medium of a flash memory type storage medium, a hard disk type storage medium, a multimedia card micro type storage medium, a card type memory (for example, an SD or XD memory, or the like), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disk. The computing device 100 may operate in connection with a web storage performing a storing function of the memory on the Internet. The description of the memory is just an example and the present disclosure is not limited thereto.

In the present disclosure, the network unit 110 may be configured regardless of communication modes such as wired and wireless modes and constituted by various communication networks including a personal area network (PAN), a wide area network (WAN), and the like. Further, the network may be known World Wide Web (WWW) and may adopt a wireless transmission technology used for short-distance communication, such as infrared data association (IrDA) or Bluetooth.

The techniques described in this specification may also be used in other networks in addition to the aforementioned networks.

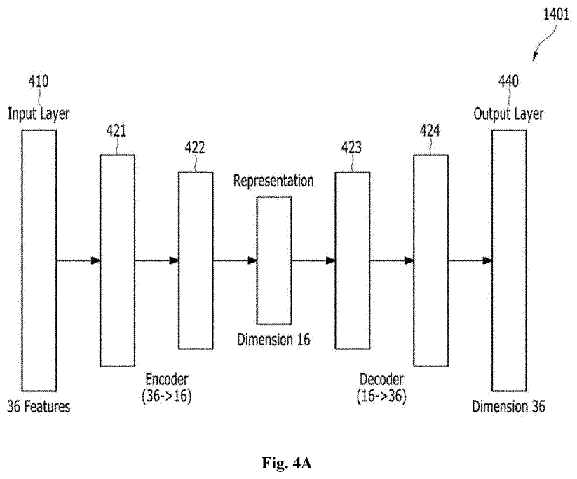

FIG. 3 is a schematic view illustrating an exemplary network function according to an exemplary embodiment of the present disclosure.

Throughout the present disclosure, a computation model, a neural network, an artificial neural network, a network function, and a neural network may be used as the same meaning. The neural network related to the attack discrimination unit of the present disclosure may be generally constituted by an aggregate of calculation units which are mutually connected to each other, which may be called nodes. The nodes may also be called neurons. The neural network is configured to include one or more nodes. The nodes (alternatively, neurons) constituting the neural networks may be connected to each other by one or more links.

In the neural network, one or more nodes connected through the link may relatively form the relationship between an input node and an output node. Concepts of the input node and the output node are relative and a predetermined node which has the output node relationship with respect to one node may have the input node relationship in the relationship with another node and vice versa. As described above, the relationship of the input node to the output node may be generated based on the link. One or more output nodes may be connected to one input node through the link and vice versa.

In the relationship of the input node and the output node connected through one link, a value of data of the output node may be determined based on data input in the input node. Here, a link connecting the input node and the output node to each other may have a weight. The weight may be variable and the weight is variable by a user or an algorithm in order for the neural network to perform a desired function. For example, when one or more input nodes are mutually connected to one output node by the respective links, the output node may determine an output node value based on values input in the input nodes connected with the output node and the weights set in the links corresponding to the respective input nodes.

As described above, in the neural network, one or more nodes are connected to each other through one or more links to form a relationship of the input node and output node in the neural network. A characteristic of the neural network may be determined according to the number of nodes, the number of links, correlations between the nodes and the links, and values of the weights granted to the respective links in the neural network. For example, when the same number of nodes and links exist and there are two neural networks in which the weight values of the links are different from each other, it may be recognized that two neural networks are different from each other.

The neural network may be constituted by a set of one or more nodes. A subset of the nodes constituting the neural network may constitute a layer. Some of the nodes constituting the neural network may constitute one layer based on the distances from the initial input node. For example, a set of nodes of which distance from the initial input node is n may constitute n layers. The distance from the initial input node may be defined by the minimum number of links which should be passed through for reaching the corresponding node from the initial input node. However, a definition of the layer is predetermined for description and the order of the layer in the neural network may be defined by a method different from the aforementioned method. For example, the layers of the nodes may be defined by the distance from a final output node.

The initial input node may mean one or more nodes in which data is directly input without passing through the links in the relationships with other nodes among the nodes in the neural network. Alternatively, in the neural network, in the relationship between the nodes based on the link, the initial input node may mean nodes which do not have other input nodes connected through the links. Similarly thereto, the final output node may mean one or more nodes which do not have the output node in the relationship with other nodes among the nodes in the neural network. Further, a hidden node may mean nodes constituting the neural network other than the initial input node and the final output node.

In the neural network according to an exemplary embodiment of the present disclosure, the number of nodes of the input layer may be the same as the number of nodes of the output layer, and the neural network may be a neural network of a type in which the number of nodes decreases and then, increases again from the input layer to the hidden layer. Further, in the neural network according to another exemplary embodiment of the present disclosure, the number of nodes of the input layer may be smaller than the number of nodes of the output layer, and the neural network may be a neural network of a type in which the number of nodes decreases from the input layer to the hidden layer. Further, in the neural network according to yet another exemplary embodiment of the present disclosure, the number of nodes of the input layer may be larger than the number of nodes of the output layer, and the neural network may be a neural network of a type in which the number of nodes increases from the input layer to the hidden layer. The neural network according to still yet another exemplary embodiment of the present disclosure may be a neural network of a type in which the neural networks are combined.

A deep neural network (DNN) may refer to a neural network that includes a plurality of hidden layers in addition to the input and output layers. When the deep neural network is used, the latent structures of data may be determined. That is, latent structures of photos, text, video, voice, and music (e.g., what objects are in the photo, what the content and feelings of the text are, what the content and feelings of the voice are) may be determined. The deep neural network may include a convolutional neural network (CNN), a recurrent neural network (RNN), an auto encoder, generative adversarial networks (GAN), a restricted Boltzmann machine (RBM), a deep belief network (DBN), a Q network, a U network, a Siam network, a Generative Adversarial Network (GAN), and the like. The description of the deep neural network described above is just an example and the present disclosure is not limited thereto.

In an exemplary embodiment of the present disclosure, the network function may include the autoencoder. The autoencoder may be a kind of artificial neural network for outputting output data similar to input data. The autoencoder may include at least one hidden layer and odd hidden layers may be disposed between the input and output layers. The number of nodes in each layer may be reduced from the number of nodes in the input layer to an intermediate layer called a bottleneck layer (encoding), and then expanded symmetrical to reduction to the output layer (symmetrical to the input layer) in the bottleneck layer. The autoencoder may perform non-linear dimensional reduction. The number of input and output layers may correspond to a dimension after preprocessing the input data. The auto encoder structure may have a structure in which the number of nodes in the hidden layer included in the encoder decreases as a distance from the input layer increases. When the number of nodes in the bottleneck layer (a layer having the smallest number of nodes positioned between an encoder and a decoder) is too small, a sufficient amount of information may not be delivered, and as a result, the number of nodes in the bottleneck layer may be maintained to be a specific number or more (e.g., half of the input layers or more).

The neural network may be learned in at least one scheme of supervised learning, unsupervised learning, semi supervised learning, or reinforcement learning. The learning of the neural network may be a process in which the neural network applies knowledge for performing a specific operation to the neural network.

The neural network may be learned in a direction to minimize errors of an output. The learning of the neural network is a process of repeatedly inputting learning data into the neural network and calculating the output of the neural network for the learning data and the error of a target and back-propagating the errors of the neural network from the output layer of the neural network toward the input layer in a direction to reduce the errors to update the weight of each node of the neural network. In the case of the supervised learning, the learning data labeled with a correct answer is used for each learning data (i.e., the labeled learning data) and in the case of the unsupervised learning, the correct answer may not be labeled in each learning data. That is, for example, the learning data in the case of the supervised learning related to the data classification may be data in which category is labeled in each learning data. The labeled learning data is input to the neural network, and the error may be calculated by comparing the output (category) of the neural network with the label of the learning data. As another example, in the case of the unsupervised learning related to the data classification, the learning data as the input is compared with the output of the neural network to calculate the error. The calculated error is back-propagated in a reverse direction (i.e., a direction from the output layer toward the input layer) in the neural network and connection weights of respective nodes of each layer of the neural network may be updated according to the back propagation. A variation amount of the updated connection weight of each node may be determined according to a learning rate. Calculation of the neural network for the input data and the back-propagation of the error may constitute a learning cycle (epoch). The learning rate may be applied differently according to the number of repetition times of the learning cycle of the neural network. For example, in an initial stage of the learning of the neural network, the neural network ensures a certain level of performance quickly by using a high learning rate, thereby increasing efficiency and uses a low learning rate in a latter stage of the learning, thereby increasing accuracy.

In learning of the neural network, the learning data may be generally a subset of actual data (i.e., data to be processed using the learned neural network), and as a result, there may be a learning cycle in which errors for the learning data decrease, but the errors for the actual data increase. Overfitting is a phenomenon in which the errors for the actual data increase due to excessive learning of the learning data. For example, a phenomenon in which the neural network that learns a cat by showing a yellow cat sees a cat other than the yellow cat and does not recognize the corresponding cat as the cat may be a kind of overfitting. The overfitting may act as a cause which increases the error of the machine learning algorithm. Various optimization methods may be used in order to prevent the overfitting. In order to prevent the overfitting, a method such as increasing the learning data, regularization, dropout of omitting a part of the node of the network in the process of learning, utilization of a batch normalization layer, etc., may be applied.

Throughout the present specification, a computation model, the neural network, a network function, and the neural network may be used as the same meaning. Hereinafter, the computation model, the neural network, the network function, and the neural network will be integrated and described as the neural network.

In the present disclosure, the attack discrimination unit which classifies the IoT network attack detection and attack type may have the neural network structure using the autoencoder and a softmax function. Specifically, in order to classify the IoT network attack detection and attack type, the structure of the attack discrimination unit 1400 learned at least twice according to the learning method of the present disclosure is illustrated in FIG. 4B. As illustrated in FIG. 4B, the attack discrimination unit 1400 of the present disclosure has a neural network structure including a part of the autoencoder and a layer of the softmax function illustrated in FIG. 4A. The learning method and the structure for the attack discrimination unit 1400 of the present disclosure will be hereinafter described in detail with reference to FIGS. 4A and 4B.

Hereinafter, the method for preventing the attack on the IoT network will be described.

According to an exemplary embodiment of the present disclosure, one or more packet data for the IoT network may be received through the network unit 110. The processor 120 may input the received packet data into the attack discrimination unit 1400 so as to generate the attack situation information.

According to an exemplary embodiment of the present disclosure, the attack situation information generated by the attack discrimination unit 1400 may include the information on whether to attack the network and the attack type information as described above. The attack discrimination unit 1400 of the present disclosure may be an artificial neural network model of a modified autoencoder structure including the softmax layer.

The attack discrimination unit 1400 of the present disclosure may be trained through primary learning and secondary learning so as to generate the attack situation information, and the training method and the structure of the attack discrimination unit 1400 will be described in detail as follows.

According to an exemplary embodiment of the present disclosure, the feature packet data for the predetermined analysis time may be generated by inputting the learning packet data into the preprocessing unit 1200. Specifically, the processor 120 may input the learning packet data into the preprocessing unit 1200 so as to generate the feature packet data by preprocessing one or more learning packet data. The preprocessing unit 1200 may extract the input learning packet data for the predetermined analysis time, and extract at least one of the basic feature or the statistical feature from the learning packet data for the predetermined analysis time. Further, the preprocessing unit 1200 may generate the feature packet data including at least one of the basic feature or the statistical feature extracted from the learning packet data. Accordingly, the feature packet data may include one or more features extracted from the learning packet data for the analysis time. That is, the feature packet data may include at least one of the basic feature or the statistical feature which is one or more features extracted from the learning packet data for the predetermined analysis time.

According to an exemplary embodiment of the present disclosure, the learning data generation unit 1300 may generate the primary learning data and the secondary learning data based on the feature packet data. Specifically, the processor 120 may input one or more feature packet data into the learning data generation unit 1300 so as to generate the primary learning data and the secondary learning data. The learning data generation unit 1300 may generate the primary learning data related to one of the normal state or the attack based on the feature packet data. That is, the primary learning data may be related to one of the normal-state network or the attacked network. Further, the learning data generation unit 1300 may also generate the primary learning data based on the learning packet data not preprocessed by the preprocessing unit 1200.

The learning data generation unit 1300 may generate the secondary learning data by labeling the feature packet data with at least one attack type. That is, the learning data generation unit 1300 may generate the secondary learning data by labeling at least one attack type with the feature packet data related to the attack. Specifically, the learning data generation unit 1300 may identify the feature packet data related to the network attack and identify the attack type related to the feature packet data. The learning data generation unit 1300 may generate the secondary learning data by labeling the feature packet data corresponding to the identified attack type with the attack type.

For example, the learning data generation unit 1300 may identify first feature packet data related to the DOS attack among one or more feature packet data, and label the first feature packet data with the DOS attack and generate the labeled first feature packet data as the secondary learning data. The feature packet data and attack type are just examples, and the feature packet data and attack type of the present disclosure should be limited and not interpreted due to the examples.

According to an exemplary embodiment of the present disclosure, the attack discrimination unit 1400 may be trained by using the primary learning data and the secondary learning data. Specifically, the processor 120 may perform the primary learning by inputting the primary learning data into a primary discrimination model 1401 constituted by the autoencoder. More specifically, a primary learning discrimination model of the present disclosure will be described as below by referring to FIG. 4A illustrated.

FIG. 4A is an exemplary diagram exemplarily illustrating a primary discrimination model constituted by an auto encoder according to an exemplary embodiment of the present disclosure.

As illustrated in FIG. 4A, the primary discrimination model 1401 is an artificial neural network model constituted only by a general autoencoder, and may include an input layer 410, a first hidden layer 421 and a second hidden layer 422 corresponding to the encoder, a third hidden layer 423 and a fourth hidden layer 424 corresponding to the decoder, and an output layer 440. The processor 120 may input and train the primary learning data for the first hidden layer 421 and the second hidden layer 422 corresponding to the encoder, and needs to define a loss function for the learning of an initial model in order to calculate a difference generated in a decoding process. For example, there is an example using a mean squared error (MSE) for the loss function of the present disclosure, which may be defined, and is specifically as follows.

$$MSE = \frac{1}{n} {{\sum }_{i = 1}}^{n} {( {y}_{i} - {t}_{i} )}^{2}$$

In the above equation, n means the number of classification results, yᵢ represents a value estimated by the neural network, tᵢ means a correct answer label, and i means the number of dimensions of data. The equation of the mean squared error is just an example, and the loss function of the present disclosure is not limited to the above equation.

According to an exemplary embodiment of the present disclosure, the processor 120 may constitute the attack discrimination unit by adding the softmax layer to the primary discrimination model of which primary learning is completed. Further, the processor 120 may perform the secondary learning by inputting the secondary learning data into the attack discrimination unit in order to generate the attack situation information including whether the attack occurs and the type of the attack. Specifically, the softmax layer of the present disclosure may be a neural network layer using a general softmax function as an activation function. More specifically, the attack discrimination unit 1400 of the present disclosure will be described as below by referring to FIG. 4B illustrated.

FIG. 4B is an exemplary diagram exemplarily illustrating an attack discrimination unit including an auto encoder and a softmax layer according to an exemplary embodiment of the present disclosure.

The attack discrimination unit 1400 may be finally constituted by adding the softmax layer to the primary discrimination model 1401 of which primary learning is completed. Specifically, the processor 120 may extract the first hidden layer 421 and the second hidden layer 422 corresponding to the encoder of the primary discrimination model 1401 of FIG. 4A, of which primary learning is completed, and constitute the attack discrimination unit 1400 by connecting the fifth hidden layer 425 corresponding to the softmax layer. As a result, the attack discrimination unit 1400 may include the input layer 410, the first hidden layer 421 and the second hidden layer 422 corresponding to the encoder which is primarily learned, the softmax layer 425, and the output layer 440. As such, the processor 120 may perform the secondary learning by inputting the secondary learning data into the attack discrimination unit 1400 in order to generate the attack situation information including whether the attack occurs and the attack type. Thereafter, the processor 120 inputs the packet data into the attack discrimination unit 1400 of which secondary learning is completed to acquire the attack situation information. The secondary learning of the present disclosure may also be preferably supervised learning, but the secondary learning of the present disclosure is not limited to the supervised learning.

Each of the primary learning and the secondary learning of the above-described learning method may be repeated at least once, and a learning order of the primary learning and the secondary learning may also be changed. Further, the hidden layers included in the primary learning model and the attack discrimination unit of FIGS. 4A and 4B are just examples, and as illustrated in FIGS. 4A and 4B, the hidden layer included in the primary learning model and the attack discrimination unit should be limited and not interpreted.

As described above, the attack discrimination unit 1400 including the autoencoder and the softmax layer may identify and predict whether the attack is performed and the attack type with higher accuracy than the general primary discrimination model 1401 learned through the primary learning and the secondary learning, and constituted only by the autoencoder.

According to an exemplary embodiment of the present disclosure, the attack situation information of the attack on the network may be generated by inputting one or more packet data for the IoT network into the attack discrimination unit 1400.

Specifically, the processor 120 may input one or more packet data for the IoT network into the attack discrimination unit 1400 of which secondary learning is completed so as to generate the attack situation information of the attack on the network. Specifically, the attack discrimination unit 1400 may calculate one or more loss values for the packet data and calculate a mean loss value of the packet data. Here, the packet data may be data received for the predetermined analysis time, and one or more packet data may be input into the attack discrimination unit 1400. As a result, the attack discrimination unit 1400 may calculate the loss value for each of one or more packet data for the predetermined analysis time by using the loss function. Here, the loss function may also be the mean squared error as described above, but the loss function of the present disclosure should be limited to the mean squared error and not interpreted. Further, the packet data is preprocessed through the preprocessing unit 1200 to generate the feature packet data, and one or more loss values for the feature packet data may also be calculated by inputting the generated feature packet data into the feature attack discrimination unit 1400. Thereafter, the attack discrimination unit 1400 may calculate a mean of the loss values calculated based on the loss function and determine the calculated mean as a mean loss value in order to discriminate whether the attack occurs or the attack type.

The attack discrimination unit 1400 may discriminate at least one of whether the attack is performed or the attack type based on the mean loss value. Specifically, the attack discrimination unit 1400 may discriminate whether the attack is performed by comparing the mean loss value with a predetermined loss threshold value. More specifically, when the mean loss value larger than the loss threshold value is calculated, the attack discrimination unit 1400 may determine that there is the attack on the network.

Since the mean loss value may be differently derived based on the attack type, the attack discrimination unit 1400 may discriminate the attack type by comparing the mean loss value with a reference mean loss value of each of the attack types learned by the attack discrimination unit. That is, the attack discrimination unit 1400 compares the mean loss value and the reference mean loss value which is the mean loss value of each of the learned attack types to determine the attack types for the packet data.

For example, the processor 120 may receive first to third packet data for a predetermined analysis time and input the received first to third packet data into the attack discrimination unit 1400. The attack discrimination unit 1400 calculates the loss values for the first packet data, the second packet data, and the third packet data, respectively, and divides a total sum of three loss values by 3 to calculate a first mean loss value. When the determined first mean loss value is larger than the loss threshold value, the attack discrimination unit 1400 may determine that there are the attacks for the first to third packet data. Further, it may also be determined that the attack corresponds to the DoS attack among the learned attack types by comparing the first mean loss value with the reference mean loss value of each of the learned attack types.

The packet data and attack type are just examples, and the packet data and attack type of the present disclosure should be limited and not interpreted due to the examples.

The attack discrimination unit 1400 may generate the attack situation information including at least one of whether the discriminated attack is performed or the attack type. As described above, the attack discrimination unit 1400 may generate the attack situation information including at least one of whether the attack is present determined based on the mean loss value or the attack type. Specifically, first attack situation information not including the attack type may be generated when the attack is not present and second attack situation information including the attack type may be generated when the attack is present.

According to an exemplary embodiment of the present disclosure, the attack analysis unit 1500 may generate the main feature information for the attack based on the attack situation information. Specifically, the processor 120 may input the attack situation information generated by the attack discrimination unit 1400 into the attack analysis unit 1500 so as to generate the main feature information. Additionally, when the attack situation information is generated by inputting the preprocessed feature packet data into the attack analysis unit 1500 as described above, the processor 120 may also input the feature packet data and the attack situation information into the attack analysis unit 1500.

When the attack analysis unit 1500 identifies that the attack occurs based on whether the attack is performed in the attack situation information, the attack analysis unit 1500 may identify the attack type of the attack situation information. Further, the attack analysis unit 1500 may calculate one or more Shapley values for features of the identified attack type. Specifically, the attack analysis unit 1500 may determine the features for the attack type based on at least one of the input feature packet data or the secondary learning data related to the identified attack type.

The determining of the features for the attack type based on the secondary learning data will be described as below, for example. When the identified attack type is the DoS attack, at least one of the basic feature or the statistical feature included in the secondary learning data may determined as the feature for at least one DoS attack by referring to the labeled secondary learning data with the DoS attack used for training the attack analysis unit 1500. The DoS attack is just the example of the attack type, and the attack type of the present disclosure should be limited and not interpreted due to the example.

The attack analysis unit 1500 of the present disclosure excludes the features for the determined attack type one by one to calculate the Shapley value for the excluded feature. For example, when first to fifth features are determined for the attack type, the Shapley value for the first feature may be calculated except for the first feature. The aforementioned features are just examples and the features of the present disclosure are not limited to the examples.

The attack analysis unit 1500 may determine at least one of the features as the main feature based on the Shapley value and generate main feature information including one or more main features. Specifically, the attack analysis unit 1500 may determine features having a Shapley value which is larger than the predetermined reference Shapley value as the main feature as described above. Further, the attack analysis unit 1500 may also arrange the features in the order of the largest Shapley value, and extract the features as large as a predetermined reference number and determine the extracted features as the main feature.

The attack analysis unit 1500 may generate the visualization analysis information representing the Shapley value of each of the features. Specifically, the attack analysis unit 1500 may generate the visualization analysis information visually expressing each of the features of calculating the Shapley value. Further, the attack analysis unit 1500 may also generate the Shapley values of the main features among the features as the visualization analysis information. For example, the visualization analysis information will be described as below by referring to FIG. 5.

FIG. 5 is an exemplary diagram exemplarily illustrating visualization analysis information according to an exemplary embodiment of the present disclosure.

As illustrated in FIG. 5, the visualization analysis information of the present disclosure may be a bar graph in which a left vertical axis may indicate flag (TCP control flag), same_dip_icmp_ratio (an ICMP ratio of the destination IP for N seconds), and same_dip_dport_pkt_cnt (destination IP for N seconds, the number of times of the port) which are the main features, and a lower horizontal axis indicates the Shapley value of each of the main features. The graph illustrated in FIG. 5 is just an example of the visualization analysis information, and the visualization analysis information of the present disclosure should be limited and not interpreted as illustrated in FIG. 5.

As such, the present disclosure may provide visualization analysis information capable of easily identifying a feature having a highest importance for the determined attack type, and presents a specific basis for the attack type identified through the visualization analysis information to plan reliability enhancement and accurate analysis for the identified attack type.

According to an exemplary embodiment of the present disclosure, the attack prevention unit 1600 may generate attack prevention information based on the main feature information. Specifically, the processor 120 may input the main feature information generated by the attack analysis unit 1500 into the attack prevention unit 1600 so as to generate the attack prevention information. The attack prevention unit 1600 may generate conditional information for the main feature included in the main feature information. Further, the attack prevention unit 1600 may generate behavior information for performing the network related control operation based on the conditional information. Here, the network related control operation may be a control operation related to network connection or packet processing such as network prevention or connection maintenance. As a result, the attack prevention unit 1600 may generate attack prevention information including the conditional information and the behavior information.

That is, the attack prevention information may be packet data including the main features satisfying conditions of the conditional information or information to perform the network control or packet data processing operation of the behavior information for the network. For example, the attack prevention information of the present disclosure may be information on the snort rule which is the general IT attack prevention rule, and will be described below in detail with reference to FIG. 6.

FIG. 6 is an exemplary diagram exemplarily illustrating attack prevention solution information according to an exemplary embodiment of the present disclosure.

Specifically, FIG. 6 exemplarily illustrates attack prevention information 500 corresponding to a snort rule 50. As illustrated in FIG. 6, behavior information 510 of the attack prevention information 500 includes information on a network drop. Further, conditional information 520 includes information on destination and source IP addresses, a port number, a packet direction, and a protocol in relation to the main feature included in the main feature information.

The attack prevention information 500 may also further include option information 530. The option information 530 may be additional other behavior information, and may include additional behavior information for searching a character string of [01 . . . a5] in the main feature, and outputting a message “DDoS Packet”. As illustrated in FIG. 6, it may be regarded that the behavior information 510 and the conditional information 520 correspond to a rule header and the option information 530 corresponds to a rule option of the snort rule.

FIG. 6 described above is just an example and the attack prevention information of the present disclosure should be limited and not interpreted due to FIG. 6 described above.

As such, in the present disclosure, there is a remarkable effect that the attack type on the IoT network may be identified and feature information of specific packet data for the identified attack type may be provided, and even attack prevention corresponding to the identified attack type may be automatically performed.

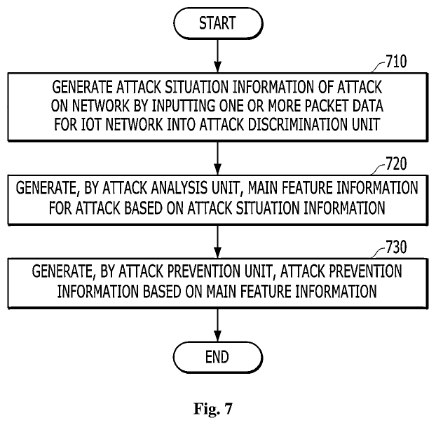

FIG. 7 is a flowchart for a method for preventing an attack on IoT network according to an exemplary embodiment of the present disclosure.

According to an exemplary embodiment of the present disclosure, attack situation information of an attack on a network may be generated by inputting one or more packet data for the IoT network into an attack discrimination unit (710).

According to an exemplary embodiment of the present disclosure, an attack analysis unit may generate main feature information for the attack based on the attack situation information (720).

According to an exemplary embodiment of the present disclosure, an attack prevention unit may generate attack prevention information based on the main feature information (730).

The steps of FIG. 7 described above may be changed in order as necessary, and at least one or more steps may be omitted or added. That is, the aforementioned steps are just an exemplary embodiment of the present disclosure and the scope of the present disclosure is not limited thereto.

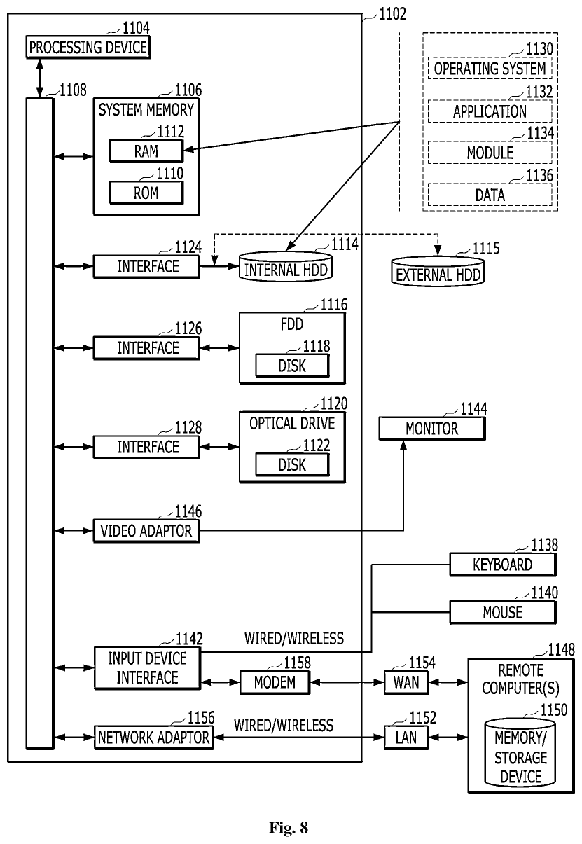

FIG. 8 is a simple and general schematic view of an exemplary computing environment in which exemplary embodiments of the present disclosure may be implemented.

It is described above that the present disclosure may be generally implemented by the computing device, but those skilled in the art will well know that the present disclosure may be implemented in association with a computer executable command which may be executed on one or more computers and/or in combination with other program modules and/or as a combination of hardware and software.

In general, the program module includes a routine, a program, a component, a data structure, and the like that execute a specific task or implement a specific abstract data type. Further, it will be well appreciated by those skilled in the art that the method of the present disclosure can be implemented by other computer system configurations including a personal computer, a handheld computing device, microprocessor-based or programmable home appliances, and others (the respective devices may operate in connection with one or more associated devices as well as a single-processor or multi-processor computer system, a mini computer, and a main frame computer.

The exemplary embodiments described in the present disclosure may also be implemented in a distributed computing environment in which predetermined tasks are performed by remote processing devices connected through a communication network. In the distributed computing environment, the program module may be positioned in both local and remote memory storage devices.

The computer generally includes various computer readable media. Media accessible by the computer may be computer readable media regardless of types thereof and the computer readable media include volatile and non-volatile media, transitory and non-transitory media, and mobile and non-mobile media. As a non-limiting example, the computer readable media may include both computer readable storage media and computer readable transmission media. The computer readable storage media include volatile and non-volatile media, transitory and non-transitory media, and mobile and non-mobile media implemented by a predetermined method or technology for storing information such as a computer readable instruction, a data structure, a program module, or other data. The computer readable storage media include a RAM, a ROM, an EEPROM, a flash memory or other memory technologies, a CD-ROM, a digital video disk (DVD) or other optical disk storage devices, a magnetic cassette, a magnetic tape, a magnetic disk storage device or other magnetic storage devices or predetermined other media which may be accessed by the computer or may be used to store desired information, but are not limited thereto.

The computer readable transmission media generally implement the computer readable command, the data structure, the program module, or other data in a carrier wave or a modulated data signal such as other transport mechanism and include all information transfer media. The term “modulated data signal” means a signal acquired by setting or changing at least one of characteristics of the signal so as to encode information in the signal. As a non-limiting example, the computer readable transmission media include wired media such as a wired network or a direct-wired connection and wireless media such as acoustic, RF, infrared and other wireless media. A combination of any media among the aforementioned media is also included in a range of the computer readable transmission media.

An exemplary environment 1100 that implements various aspects of the present disclosure including a computer 1102 is shown and the computer 1102 includes a processing device 1104, a system memory 1106, and a system bus 1108. The system bus 1108 connects system components including the system memory 1106 (not limited thereto) to the processing device 1104. The processing device 1104 may be a predetermined processor among various commercial processors. A dual processor and other multi-processor architectures may also be used as the processing device 1104.

The system bus 1108 may be any one of several types of bus structures which may be additionally interconnected to a local bus using any one of a memory bus, a peripheral device bus, and various commercial bus architectures. The system memory 1106 includes a read only memory (ROM) 1110 and a random access memory (RAM) 1112. A basic input/output system (BIOS) is stored in the non-volatile memories 1110 including the ROM, the EPROM, the EEPROM, and the like and the BIOS includes a basic routine that assists in transmitting information among components in the computer 1102 at a time such as in-starting. The RAM 1112 may also include a high-speed RAM including a static RAM for caching data, and the like.

The computer 1102 also includes an interior hard disk drive (HDD) 1114 (for example, EIDE and SATA), in which the interior hard disk drive 1114 may also be configured for an exterior purpose in an appropriate chassis (not illustrated), a magnetic floppy disk drive (FDD) 1116 (for example, for reading from or writing in a mobile diskette 1118), and an optical disk drive 1120 (for example, for reading a CD-ROM disk 1122 or reading from or writing in other high-capacity optical media such as the DVD, and the like). The hard disk drive 1114, the magnetic disk drive 1116, and the optical disk drive 1120 may be connected to the system bus 1108 by a hard disk drive interface 1124, a magnetic disk drive interface 1126, and an optical drive interface 1128, respectively. An interface 1124 for implementing an exterior drive includes at least one of a universal serial bus (USB) and an IEEE 1394 interface technology or both of them.

The drives and the computer readable media associated therewith provide non-volatile storage of the data, the data structure, the computer executable instruction, and others. In the case of the computer 1102, the drives and the media correspond to storing of predetermined data in an appropriate digital format. In the description of the computer readable media, the mobile optical media such as the HDD, the mobile magnetic disk, and the CD or the DVD are mentioned, but it will be well appreciated by those skilled in the art that other types of media readable by the computer such as a zip drive, a magnetic cassette, a flash memory card, a cartridge, and others may also be used in an exemplary operating environment and further, the predetermined media may include computer executable commands for executing the methods of the present disclosure.

Multiple program modules including an operating system 1130, one or more application programs 1132, other program module 1134, and program data 1136 may be stored in the drive and the RAM 1112. All or some of the operating system, the application, the module, and/or the data may also be cached in the RAM 1112. It will be well appreciated that the present disclosure may be implemented in operating systems which are commercially usable or a combination of the operating systems.

A user may input instructions and information in the computer 1102 through one or more wired/wireless input devices, for example, pointing devices such as a keyboard 1138 and a mouse 1140. Other input devices (not illustrated) may include a microphone, an IR remote controller, a joystick, a game pad, a stylus pen, a touch screen, and others. These and other input devices are often connected to the processing device 1104 through an input device interface 1142 connected to the system bus 1108, but may be connected by other interfaces including a parallel port, an IEEE 1394 serial port, a game port, a USB port, an IR interface, and others.

A monitor 1144 or other types of display devices are also connected to the system bus 1108 through interfaces such as a video adapter 1146, and the like. In addition to the monitor 1144, the computer generally includes other peripheral output devices (not illustrated) such as a speaker, a printer, others.

The computer 1102 may operate in a networked environment by using a logical connection to one or more remote computers including remote computer(s) 1148 through wired and/or wireless communication. The remote computer(s) 1148 may be a workstation, a computing device computer, a router, a personal computer, a portable computer, a micro-processor based entertainment apparatus, a peer device, or other general network nodes and generally includes multiple components or all of the components described with respect to the computer 1102, but only a memory storage device 1150 is illustrated for brief description. The illustrated logical connection includes a wired/wireless connection to a local area network (LAN) 1152 and/or a larger network, for example, a wide area network (WAN) 1154. The LAN and WAN networking environments are general environments in offices and companies and facilitate an enterprise-wide computer network such as Intranet, and all of them may be connected to a worldwide computer network, for example, the Internet.

When the computer 1102 is used in the LAN networking environment, the computer 1102 is connected to a local network 1152 through a wired and/or wireless communication network interface or an adapter 1156. The adapter 1156 may facilitate the wired or wireless communication to the LAN 1152 and the LAN 1152 also includes a wireless access point installed therein in order to communicate with the wireless adapter 1156. When the computer 1102 is used in the WAN networking environment, the computer 1102 may include a modem 1158 or has other means that configure communication through the WAN 1154 such as connection to a communication computing device on the WAN 1154 or connection through the Internet. The modem 1158 which may be an internal or external and wired or wireless device is connected to the system bus 1108 through the serial port interface 1142. In the networked environment, the program modules described with respect to the computer 1102 or some thereof may be stored in the remote memory/storage device 1150. It will be well known that an illustrated network connection is exemplary and other means configuring a communication link among computers may be used.

The computer 1102 performs an operation of communicating with predetermined wireless devices or entities which are disposed and operated by the wireless communication, for example, the printer, a scanner, a desktop and/or a portable computer, a portable data assistant (PDA), a communication satellite, predetermined equipment or place associated with a wireless detectable tag, and a telephone. This at least includes wireless fidelity (Wi-Fi) and Bluetooth wireless technology. Accordingly, communication may be a predefined structure like the network in the related art or just ad hoc communication between at least three devices.

The wireless fidelity (Wi-Fi) enables connection to the Internet, and the like without a wired cable. The Wi-Fi is a wireless technology such as the device, for example, a cellular phone which enables the computer to transmit and receive data indoors or outdoors, that is, anywhere in a communication range of a base station. The Wi-Fi network uses a wireless technology called IEEE 802.11(a, b, g, and others) in order to provide safe, reliable, and high-speed wireless connection. The Wi-Fi may be used to connect the computers to each other or the Internet and the wired network (using IEEE 802.3 or Ethernet). The Wi-Fi network may operate, for example, at a data rate of 11 Mbps (802.11a) or 54 Mbps (802.11b) in unlicensed 2.4 and 5 GHz wireless bands or operate in a product including both bands (dual bands).

It will be appreciated by those skilled in the art that information and signals may be expressed by using various different predetermined technologies and techniques. For example, data, instructions, commands, information, signals, bits, symbols, and chips which may be referred in the above description may be expressed by voltages, currents, electromagnetic waves, magnetic fields or particles, optical fields or particles, or predetermined combinations thereof.

It may be appreciated by those skilled in the art that various exemplary logical blocks, modules, processors, means, circuits, and algorithm steps described in association with the exemplary embodiments disclosed herein may be implemented by electronic hardware, various types of programs or design codes (for easy description, herein, designated as software), or a combination of all of them. In order to clearly describe the intercompatibility of the hardware and the software, various exemplary components, blocks, modules, circuits, and steps have been generally described above in association with functions thereof. Whether the functions are implemented as the hardware or software depends on design restrictions given to a specific application and an entire system. Those skilled in the art of the present disclosure may implement functions described by various methods with respect to each specific application, but it should not be interpreted that the implementation determination departs from the scope of the present disclosure.

Various embodiments presented herein may be implemented as manufactured articles using a method, a device, or a standard programming and/or engineering technique. The term manufactured article includes a computer program, a carrier, or a medium which is accessible by a predetermined computer-readable storage device. For example, a computer-readable storage medium includes a magnetic storage device (for example, a hard disk, a floppy disk, a magnetic strip, or the like), an optical disk (for example, a CD, a DVD, or the like), a smart card, and a flash memory device (for example, an EEPROM, a card, a stick, a key drive, or the like), but is not limited thereto. Further, various storage media presented herein include one or more devices and/or other machine-readable media for storing information.

It will be appreciated that a specific order or a hierarchical structure of steps in the presented processes is one example of exemplary accesses. It will be appreciated that the specific order or the hierarchical structure of the steps in the processes within the scope of the present disclosure may be rearranged based on design priorities. Appended method claims provide elements of various steps in a sample order, but the method claims are not limited to the presented specific order or hierarchical structure.

The description of the presented exemplary embodiments is provided so that those skilled in the art of the present disclosure use or implement the present disclosure. Various modifications of the exemplary embodiments will be apparent to those skilled in the art and general principles defined herein can be applied to other exemplary embodiments without departing from the scope of the present disclosure. Therefore, the present disclosure is not limited to the exemplary embodiments presented herein, but should be interpreted within the widest range which is coherent with the principles and new features presented herein.

What is claimed is:

1. A method for preventing an attack on an IoT network, the method comprising:
generating attack situation information of an attack on a network by inputting one or more packet data for the IoT network into an attack discrimination unit;
generating, by an attack analysis unit, main feature information for the attack based on the attack situation information; and
generating, by an attack prevention unit, attack prevention information based on the main feature information,
wherein the attack discrimination unit is an artificial neural network model of a modified autoencoder structure including a softmax layer.

2. The method of claim 1, further comprising:
generating feature packet data for a predetermined analysis time by inputting learning packet data into a preprocessing unit;
generating, by a learning data generation unit, primary learning data and secondary learning data based on the feature packet data, and
training the attack discrimination unit by using the primary learning data and the secondary learning data,
wherein the feature packet data includes one or more features extracted from the learning packet data for the analysis time.

3. The method of claim 2, wherein the generating, by the learning data generation unit, of the primary learning data and the secondary learning data based on the feature packet data further includes
generating the primary learning data related to one of a normal state or an attack based on the feature packet data, and
generating the secondary learning data by labeling the feature packet data with at least one attack type.

4. The method of claim 2, wherein the training of the attack discrimination unit by using the primary learning data and the secondary learning data includes
performing primary learning by inputting the primary learning data into a primary discrimination model constituted by an autoencoder,
constituting the attack discrimination unit by adding the softmax layer to the primary discrimination model of which the primary learning is completed, and
performing secondary learning by inputting the secondary learning data into the attack discrimination unit in order to generate the attack situation information including whether the attack occurs and the type of the attack.

5. The method of claim 1, wherein the generating of the attack situation information of the attack on the network by inputting one or more packet data for the IoT network into the attack discrimination unit includes
calculating, by the attack discrimination unit, one or more loss values for the packet data, and calculating a mean loss value of the packet data,
discriminating at least one of whether the attack occurs or the attack type based on the mean loss value, and
generating the attack situation information including at least one of whether the attack occurs or the attack type discriminated.

6. The method of claim 5, wherein the discriminating of at least one of whether the attack occurs or the attack type based on the mean loss value includes at least one of
discriminating whether the attack occurs by comparing the mean loss value with a predetermined loss threshold value, or
discriminating, by the attack discrimination unit, the attack type by comparing the mean loss value with a reference mean loss value of each of the learned attack types.

7. The method of claim 1, wherein the generating, by the attack analysis unit, of the main feature information having a high relation to the attack based on the attack situation information includes
when the attack analysis unit identifies that the attack occurs based on whether the attack is performed in the attack situation information, identifying, by the attack analysis unit, the attack type of the attack situation information,
calculating, by the attack analysis unit, one or more Shapley values for features of the identified attack type, and
determining, by the attack analysis unit, at least one of the features as a main feature based on the Shapley value and generating the main feature information including one or more main features.

8. The method of claim 7, wherein the generating, by the attack analysis unit, of the main feature information having the high relation to the attack based on the attack situation information further includes
generating, by the attack analysis unit, visualization analysis information representing the Shapley value of each of the features.

9. The method of claim 1, wherein the attack prevention information includes
conditional information for a main feature included in the main feature information, and
behavior information for performing a network related control operation based on the conditional information.

10. A computing device for preventing an attack on an IoT network, the computing device comprising:
a processor;
a memory; and
a network unit,
wherein the processor is configured to
generate attack situation information of an attack on a network by inputting one or more packet data for the IoT network into an attack discrimination unit,
generate, by an attack analysis unit, main feature information for the attack based on the attack situation information, and
generate, by an attack prevention unit, attack prevention information based on the main feature information, and
wherein the attack discrimination unit is an artificial neural network model of a modified autoencoder structure including a softmax layer.
